(19) United States
(12) Patent Application Publication
(10) Pub. No.: US 2009/0145915 A1
(43) Pub. Date: Jun. 11, 2009

(54) Bottle stopper holder and drip reducer

(76) Inventor: Linda Druckerman Huff, San Jose, CA (US)

Correspondence Address: LINDA D. HUFF, 4215 VISTAMONT DRIVE, SAN JOSE, CA, 95118, US

(21) Appl. No.: 12/313,579

(22) Filed: Nov. 21, 2008

Related U.S. Application Data
(60) Provisional application No. 61/005,769, filed on Dec. 7, 2007.

(51) Int. Cl. B65D 51/24; B23P 11/00

(52) U.S. Cl. 220/744; 29/428

(57) ABSTRACT

In an embodiment, a holder for a bottle stopper comprising of a strip of material that is compressible and elastic. The holder for the bottle stopper may be attached to the neck of a bottle by sliding individual beads along the compressible material.

### CROSS-REFERENCE TO RELATED APPLICATIONS

This application claims priority benefit of U.S. Provisional Patent Application, entitled, “BOTTLE STOPPER HOLDER AND DRIP REDUCER,” Ser. No. 61/005,769, by Linda D. Huff, filed Dec. 7, 2007, which is incorporated herein by reference.

### BACKGROUND

Others drip stopping devices exist, and other cork holders exist.

### BRIEF DESCRIPTION OF THE DRAWINGS

FIG. 1 shows a flat view of an embodiment of a bottle-stopper-holder-and-drip-reducer.

FIG. 2 shows a side view of an embodiment of a bottle-stopper-holder-and-drip-reducer.

FIG. 3 shows an angled view of an embodiment of a bottle-stopper-holder-and-drip-reducer.

FIG. 4 shows a view of an embodiment of a bottle-stopper-holder-and-drip-reducer while on a bottle.

FIG. 5 shows different parts of an embodiment of a disassembled bottle-stopper-holder-and-drip-reducer.

### DETAILED DESCRIPTION

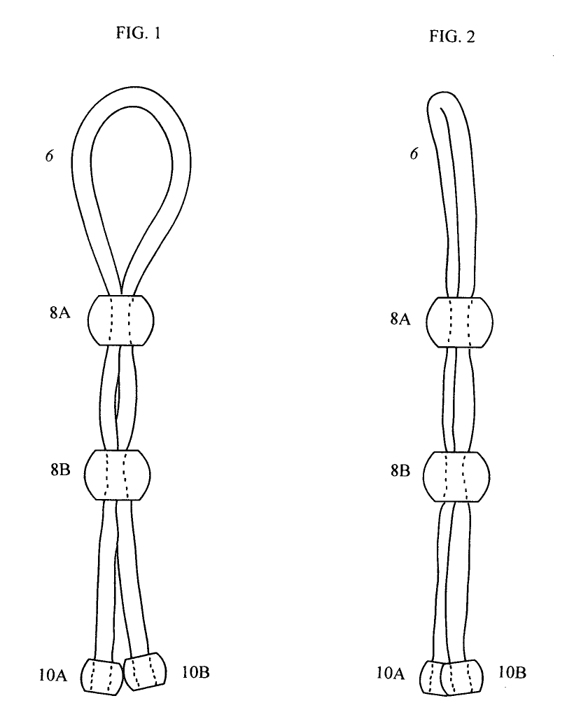

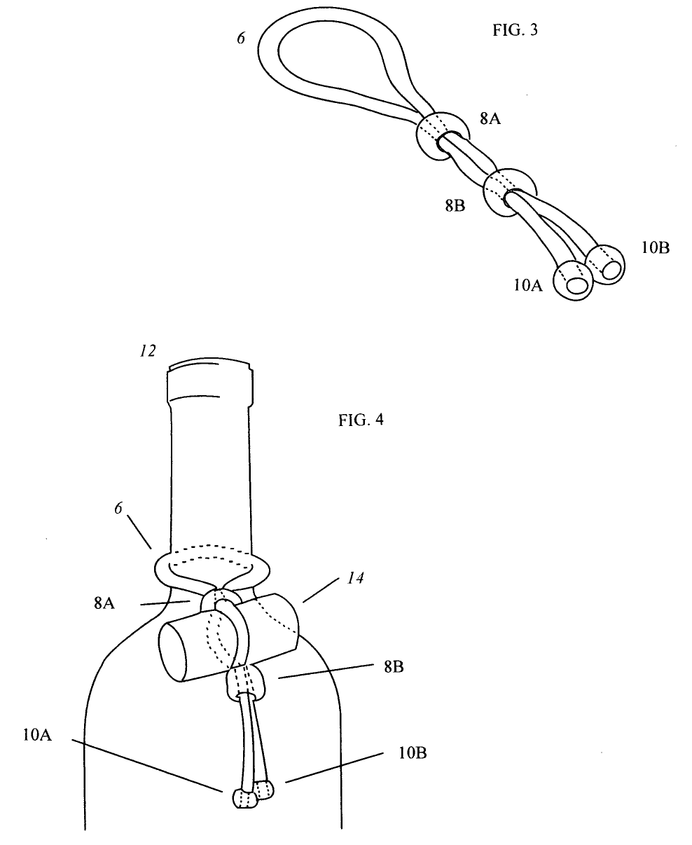

The bottle-stopper-holder-and-drip-reducer may be an apparatus for securing a cork or other bottle stopper to the neck of a bottle and may also function as a drip reducing mechanism. In one embodiment, a piece of tubing 6 (FIG. 1) is folded in half. In an embodiment, the tubing is a 12″ long latex tube having an Inner Diameter (ID) of ⅛″, an Outer Diameter (OD) of 3/16″, and a wall thickness of 1/32″. The larger the OD the better the tube functions as a drip stopper, but it may be harder to bend the tube if the OD is larger. In an embodiment, bottle-stopper-holder-and-drip-reducer when on a bottle holds at least 15 drops of a fluid (or at least 3 ml of fluid). In another embodiment, bottle-stopper-holder-and-drip-reducer holds at least 10 drops (or at least 2 ml) of fluid.

In an embodiment, tubing 6 is between 11.75″ and 12.25″ or between 11″ and 13″. In an embodiment, tubing 6 has a tensile PSI of 3500, an elongation at break(%) of 750, and a Shore A softness or durometer of 35±5.

In an embodiment, tubing 6 has the following specifications.

| | |
|---|---|
| Type | Super Soft Latex Rubber Tubing |
| Material | Latex |
| Shape | Single Line |
| Outside Dia. | 3/16″ (.1875″) |
| Inside Dia. | ⅛″ (.125″) |
| Wall Thickness | 1/32″ (.0312″) |
| Reinforcement | Unreinforced |
| Color | Opaque Black |
| Maximum Pressure | 20 psi @ 70° F. |
| Operating Temperature | 0° to +158° F. |
| Range | |
| Performance | Abrasion-Resistant |
| Characteristics | |
| Bend Radius | 2- 3/32″ (2.0937″) |
| Durometer | 35 A (Very Soft) |
| Tensile Strength | 4,000 psi |
| Sterilize With | Gas and Steam (autoclave) |
| Specifications Met | Federal Specifications (FED) and |
| | Military Specifications (MIL) |
| MIL Specification | MIL-T-36966/A-A-53848 |
| Federal Specification | FED A-A-52047C |
| Compatible Fittings | Barbed |
| Available Lengths | 10 and 25 feet |
| Length Note | This tubing can stretch up to 3 times its |
| | length and still spring back to its |
| | original shape. |
| Chemical Compatibility | 5543KAC |
| Link | |

However, other types of tubing may be used instead of one having the above specification. In an embodiment, tubing 6 may be soft with good impact and abrasion resistance. As a result of the elasticity of tubing 6, tubing 6 and will resume its original shape after bending and stretching. In an embodiment, tubing 6 is made from a colloidal suspension of very small polymer particles in water that is used to make rubber. In an embodiment tubing 6 is made from natural rubber. For example, tubing 6 may be made from the protective fluid contained beneath the bark of the Hevea brasilienesis (rubber) tree, which may be mixed with sulfur and heated (e.g., at 170 degrees for about 10 minutes).

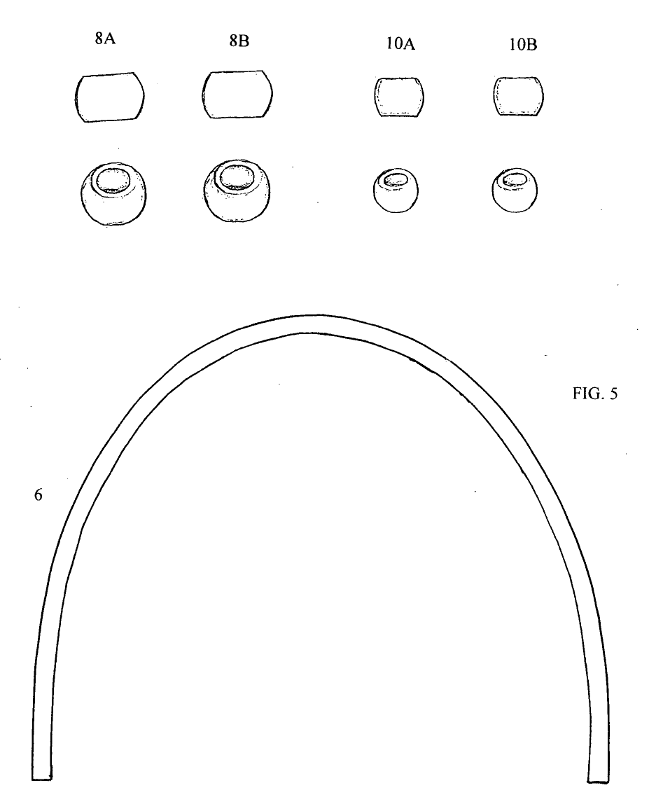

In an embodiment, two beads 8a and 8b (FIG. 1) are placed over the folded end of tubing 6 and slid down tubing 6 to create a loop at the top. In an embodiment beads 8a and 8b have a length of 16 mm and a hole with an ID of 8 mm. The ID of beads 8a and 8b are chosen so as to create enough friction so that beads 8a and 8b can be easily slid by a person pushing beads 8a and 8b along tubing 6, but do not significantly loosen or slide on their own during a period of time in which someone eats a meal or has a party (e.g., 2 hours, 4 hours, or 6 hours), so as to keep tubing 6 securely tight around the neck of bottle 12 (FIG. 4) and to securely hold a bottle stopper throughout the course of the meal or party. Since tubing 6 is hollow, tubing 6 compresses easily to allow a bead to be slid on it, and after the bead has been placed at a desired location on tubing 6, as a result of the compression, tubing 6 presses against the bead to hold the bead in place.

In an embodiment, there a space is left between beads 8a and 8b. In an embodiment the space may be 1″. In an embodiment two terminal endings 10a and 10b are attached to the ends of tubing 6. In an embodiment, terminal endings 10a and 10b are beads that are 9 mm in height and have a hole with an ID of 5 mm. In an embodiment, terminal endings 10a and 10b are secured in place with glue. In another embodiment, terminal endings 10a and 10b are heated slightly to fuse together the material that is at the interface of terminal endings 10a and 10b and of tubing 6. In another embodiment, terminal endings 10a and 10b crimp the ends of tubing 6 to secure terminal endings 10a and 10b to tubing 6. Additionally, terminal endings 10a and 10b prevent beads 8a and 8b from sliding off of the ends that has weights 10a and 10b.

### How the Bottle-Stopper-Holder-and-Drip-Reducer Achieves its Results

Loop of tubing 6 is placed over neck of bottle 12. Bead 8a is slid up tubing 6 to form a tight connection to neck of bottle 12. This prevents a drop of fluid from sliding down the neck of bottle 12 beyond tubing 6. Tubing 6 acts as a dam or reservoir for the drop of fluid. Tubing 6 may hold the drop of fluid in place until the drop evaporates. By using bead 8a to tighten tubing 6 around the neck of bottle 12, different diameter bottle necks may be accommodated.

Cork 14 may be placed between a doubled portion of tubing 6 between beads 8a and 8b. A doubled portion of tubing refers to two portions of tubing held side-by-side next to one another, between beads 8a and 8b and by beads 8a and 8b. Bead 8b may be cinched up to cork 14 to hold cork 14 in place. Holding the cork 14 in the portion of tubing 6 that is between beads 8a and 8b eliminates the need to find a place to set the cork 14 elsewhere, and reduces the chances of misplacing or contaminating the cork. The bottle-stopper-holder-and-drip-reducer may be sold with a bottle of wine or other fluid or separately.

### Alternatives and Extension

In alternative embodiments, the OD may be ⅛″, 3/16″, ¼″, 5/16″ and the wall thickness of tubing 6 may 1/32″, so that the tubing is not as stiff and compresses easily when sliding on beads and securing around bottle 12. Tubing 6 may also be made from neoprene, nylon, and/or plastic. However, rubber or latex grips the bottle better, is more elastic, and bends easier than these other materials.

Tubing other than latex may be substituted for the latex. In other embodiments, cords, strings or wires may be used instead of the tubing. For example, an elastic strip of material which may have a circular, oval, square, rectangular, hexagonal, octagonal, or other cross sectional shape, which may have a hollow or solid inside, may be used instead of a tube. In an embodiment, the strip of material is easily compressed.

The length of tubing 6 may vary to accommodate different size bottles. Similar results can be achieved by using various thicknesses of tubing. In an embodiment, the length of the tubing 6 is chosen so when bottle-stopper-holder-and-drip-reducer is in-use on a bottle, weights 10a and 10b do not touch the table. In an embodiment, the length of the tubing 6 is chosen so when bottle-stopper-holder-and-drip-reducer is in-use on a bottle, weights 10a and 10b are suspended to not touch the side of the bottle and are kept far enough away from the side of the bottle that weights 10a and 10b do not clink against the side of the bottle and make noise. In one embodiment, the length of tubing 6 is based on the sizes of most wine bottles (and chosen to prevent or reduce the likelihood of weights 10a and 10b from clinking on the side of the bottle). In another embodiment, the length of tubing 6 is tailored for a particular bottle and cork combination (and chosen to prevent or reduce the likelihood of weights 10a and 10b from clinking on the side of the bottle). In an embodiment, the length of tubing 6 must be at least

(length of tubing 6)=(length of the circumference of the bottle neck)+2×(length of bead 8a)+2×(length of bead 8b)+(length of circumference of the cork)+(a length that allows beads 8a and 8b to slide).

In an embodiment, the length that allows beads 8a and 8b to slide may be twice the sum of the lengths of beads 8a and 8b. In an embodiment, the length that allows beads 8a and 8b to slide is 1 to 4 inches. In yet another embodiment, the length that allows beads 8a and 8b to slide is just a small amount of tubing that only allows a small movement of beads 8a and 8b for loosening and tightening (e.g. 0.1″). In an embodiment, the circumference of the base of the bottle necks is between 3.75″ and 4.125″, the circumference of the cork is between 2.75″ and 2.9″. Thus, for 9 mm (0.354″) high beads, tubing 6 should be between 8″ and 8.6″ if the length of that allows beads 8a and 8b to slide only slightly. If the amount of that allows the beads 8a and 8b to slide is between 1 and 4 inches, then the length of the tubing 6 is between 9″ and 13″.

The beads may vary in size, composition, shape, design, and hole size. The beads may be replaced with other mechanisms for holding two tubes together, such as a disc, cylinder, cube, or other three-dimensional shape, with a hole in the center. For example figurines with holes in them may be used instead of beads. In an embodiment, bead 8a, bead 8b, weight 10a, and/or weight 10b may be coated with a soft material or made from a soft material, to prevent or reduce the likelihood of bead 8a, bead 8b, weight 10a, and/or weight 10b clinking on the bottle and making noises. In an embodiment, the soft material is rubber, latex, or a soft plastic.

Table of some components of an embodiment of the bottle-stopper-holder-and-drip-reducer

| | |
|---|---|
| 6 | 12″ latex rubber tubing ID ⅛″, OD 3/16″, Wall thickness 1/32″ |
| 8a | 16 mm wood bead with 8 mm hole |
| 8b | 16 mm wood bead with 8 mm hole |
| 10a | 9 mm bead with 4.5-5 mm hole |
| 10b | 9 mm bead with 4.5-5 mm hole |
| 12 | wine bottle |
| 14 | cork |

1. A device comprising:
a strip of material that is compressible and elastic; and
a pair of holders that hold two ends of the strip together, each of the holders compressing the two ends of the strip of material and each of the holders being capable of individually sliding along the two ends of the strip of material.

2. The device of claim 1, the strip of material being a tube.

3. A method comprising:
folding a strip of material, the strip of material being is compressible and elastic; and
placing a pair of holders that hold two ends of the strip together keeping the strip of material folded, each of the holders compressing the two ends of the strip of material and each of the holders being capable of individually sliding along the two ends of the strip of material.

4. The device of claim 3, the strip of material being a tube.
